(19) United States
(12) Patent Application Publication
(10) Pub. No.: US 2009/0239968 A1
(43) Pub. Date: Sep. 24, 2009

(54) Resin composition, resin composition for lens, and cured product thereof

(76) Inventors: Noriko Kiyoyanagi, Tokyo (JP); Hideyuki Ota, Tokyo (JP); Ritsuko Shitara, Tokyo (JP)

Correspondence Address: Nields, Lemack & Frame, LLC, 176 E. Main Street, Suite #5, Westborough, MA, 01581, US

(21) Appl. No.: 12/309,303

(22) PCT Filed: Jul. 26, 2007
(86) PCT No.: PCT/JP2007/064648

§ 371 Date: Mar. 26, 2009

(30) Foreign Application Priority Data
Jul. 27, 2006 (JP) 2006 204281

(51) Int. Cl. C08F 2/46

(52) U.S. Cl. 522/95

(57) ABSTRACT

Disclosed is a lens-shaped cured product which is excellent in releasability, shape reproducibility and adhesion, while having high refractive index. The lens shape of the cured product is hardly deformed when the cured product is exposed to force or temperature change. Also disclosed is a resin composition having good stability, which enables obtaining such a cured product. Specifically, disclosed is a resin composition containing polyfunctional (meth)acrylate (A) having three or more (meth)acryloyl groups in a molecule, urethane (meth)acrylate which is a reaction product of a diol compound (b-1) having molecular weight of 48-1000, aromatic polyisocyanate (B-2) and hydroxylated (meth)acrylate (b-3), an o-phynylphenol polyethoxy acrylate (C) having an average repetition number of ethoxy groups of 1-3, and a photopolymerization initiator (D).

### TECHNICAL FIELD

The present invention relates to a UV curable resin composition and a cured product thereof. More specifically, the present invention relates to a resin composition and a cured product thereof suitable in particular for lenses such as fresnel lenses, lenticular lenses, prism lenses and microlenses.

### BACKGROUND ART

Conventionally, these kinds of lenses are formed by a method such as a pressing method or a casting method. The former pressing method is of poor productivity due to manufacturing a lens through a heating, pressing, and cooling cycle. The latter casting method has a problem of high manufacturing cost. This is because a monomer or monomers are incorporated into molds and polymerized, requiring a multiplicity of molds and long manufacturing time. In order to overcome such problems, various suggestions using UV curable resin compositions have been made (Patent document 1 and Patent document 2).

A method for manufacturing a transparent-type screen by using these UV-curable resin compositions is known. However, these conventional resin compositions have problems of poor adhesion to a substrate, and poor releasability from a mold. When adhesion is poor, the kind of a usable substrate is restricted, and it is difficult to obtain optical properties intended. When releasability is poor, a resin remains in the mold at the time that the resin is separated from the mold and it is impossible to reuse the mold. In addition, the resin compositions of good adhesion are apt to be of poor releasability due to good adhesion to the mold as well. On the other hand, the resin compositions of good releasability are apt to be of poor adhesion. Accordingly, there is a need for resin compositions capable of satisfying both of adhesion to a substrate and releasability from a mold. Under such circumstances, resin compositions including o-phenylphenol polyethoxy acrylates is described in Patent document 3.

However, the shape of the lens which is used for these transparent-type screens crushes or deforms, when the lens is exposed to force or temperature change to process the lens into a finer shape or into thinner thickness in obtaining a high defined picture of recent years.

Although these problems can be overcome by raising the softening point or the hardness of the UV curable resin, it is likely that adhesion to a substrate easily deteriorates and curing shrinkage degree becomes high, making it difficult to mold such a resin and making it difficult to process the resin into an accurate shape.

Patent document 1: Japanese Patent Application Laid-Open No. 63-167301

Patent document 2: Japanese Patent Application Laid-Open No. 63-199302

Patent document 3: Japanese Patent Application Laid-Open No. 5-65318

### DISCLOSURE OF THE INVENTION

### Problem to be Solved by the Invention

The object of the present invention is to provide a cured product which is excellent in releasability, shape reproducibility and adhesion, and which has a high refractive index, and the shape of a lens using the cured product hardly deforms when the lens is exposed to force or temperature change, and to provide a resin composition with good stability to give the same.

### Means for Solving Problem

As a result of assiduous research to solve the above-mentioned problems, the inventors of the present invention found that a UV curable resin composition with a specific composition settles the problem, and thereby the present invention has been made.

That is to say, the present invention relates to the followings.
(1) A resin composition including multifunctional (meth)acrylate (A) having three or more (meth)acryloyl groups in a molecule thereof, urethane (meth) acrylate (B) which is a reaction product of a diol compound (b-1) having molecular weight of 48 to 1000, aromatic polyisocyanate (b-2), and hydroxyl group-containing (meth)acrylate (b-3), o-phenylphenol polyethoxy acrylate (C) having an average repetition number of ethoxy groups of 1 to 3, and a photopolymerization initiator (D);
(2) The resin composition described in (1), wherein the multifunctional (metha)acrylate (A) is pentaerythritol triacrylate or dipentaerythritol hexaacrylate;
(3) The resin composition described in (1) or (2), wherein the diol compound (b-1) is one or more compounds selected from bisphenol A polyethoxydiol having a repetition number of ethoxy groups of from 2 to 8, and bisphenol A polypropoxydiol having a repetition number of propoxy groups of 2 to 6;
(4) The resin composition described in any one of (1) to (3), further comprising (metha) acrylate monomer other than the (A) component, the (B) component and the (C) component, and/or (metha) acrylate oligomer other than the (A) component, the (B) component, and the (C) component;
(5) The resin composition described in any one of (1) to (4), comprising 10 to 40 wt. % of the (A) component, 10 to 28 wt. % of the (B) component, and 10 to 60 wt. % of the (C) component in the composition based on 100 wt % of the (A) component +the (B) component+the (C) component;
(6) The resin composition described in any one of (1) to (5), used for lenses;
(7) A cured product obtained by curing the resin composition described in any one of (1) to (6) and having a refractive index of 1.55 or more at 25° C.; and
(8) A lens using the cured product described in (7).

### Effects of the Invention

The resin composition of the present invention is stable, and the cured product thereof is excellent in releasability, shape reproducibility, and adhesion, and has a high refractive index and a high glass transition temperature and the shape of the lens thereof hardly deforms even when exposed to heating or force. Therefore, it is suitable in particular for lenses such as fresnel lenses, lenticular lenses, prism lenses, and microlenses.

### BEST MODE FOR CARRYING OUT THE INVENTION

The resin composition of the present invention includes multifunctional (meth)acrylate (A) having three or more (meth)acryloyl groups in a molecule, urethane (meth)acrylate (B) which is a reaction product of a diol compound (b-1) having molecular weight of 48 to 1000, aromatic polyisocyanate (b-2), and hydroxyl group-containing (metha)acrylate (b-3), o-phenylphenol polyethoxy acrylate (C) having an average repetition number of ethoxy groups of 1 to 3, and a photopolymerization initiator (D).

Examples of the diol compound (b-1) having molecular weight of 48 to 1000 include diol compounds (b-1-1) having molecular weight of 48 to 1000 such as ethylene glycol,
diethylene glycol, triethylene glycol, propylene glycol,
dipropylene glycol, tripropylene glycol, 1,4-butanediol,
neopentyl glycol, 1,6-hexanediol, 1,8-octanediol,
1,9-nonanediol, 2-methyl-1,8-octanediol,
3-methyl-1,5-pentanediol, 2,4-diethyl-1,5-pentanediol,
2-butyl-2-ethyl-1,3-propanediol, cyclohexane-1,4-dimethanol,
polyethylene glycol, polypropylene glycol, bisphenol A
polyethoxydiol and bisphenol A polypropoxydiol, and
polyesterdiol compounds (b-1-2) which are reaction products of
   these diol compounds (b-1-1) and dibasic acids (for example, succinic acid, adipic acid, azelaic acid, dimer acid, isophthalic acid, terephthalic acid, and phthalic acid) or anhydrides thereof.

The diol component (b-1) is preferably bisphenol A polyethoxydiol, bisphenol A polypropoxydiol, 3-methyl-1,5-pentanediol and/or 2,4-diethyl-1,5-pentanediol.

The diol compound (b-1) having molecular weight of 48 to 1000 is more preferably one or more compounds selected from bisphenol A polyethoxydiol having a repetition number of ethoxy groups of 2 to 8, and bisphenol A polypropoxydiol having a repetition number of propoxy groups of 2 to 6.

Examples of the aromatic polyisocyanate (b-2) include
2,4-tolylene diisocyanate, 1,3-xylylene diisocyanate,
p-phenylene diisocyanate, 3,3′-dimethyl-4,4′-diisocyanate,
6-isopropyl-1,3-phenyl diisocyanate and 1,5-naphthalene
diisocyanate.

Among them, the aromatic polyisocyanate (b-2) is preferably 2,4-tolylene diisocyanate and/or 1,3-xylylene diisocyanate.

Examples of the hydroxyl group-containing (meth) acrylate
(b-3) include 2-hydroxyethyl (meth) acrylate, 2-hydroxypropyl
(meth)acrylate, 1,4-butanediol mono(meth)acrylate,
polyethylene glycol mono(meth)acrylate, polypropylene glycol
mono(meth)acrylate, pentaerythritol tri(meth)acrylate, an
ε-caprolactone adduct of 2-hydroxyethyl (meth)acrylate, and
2-hydroxy-3-phenyloxypropyl (meth)acrylate.

Among them, the hydroxyl group-containing (meth) acrylate (b-3) is preferably 2-hydroxyethyl (meth)acrylate, 2-hydroxypropyl (meth)acrylate, and/or polyethylene glycol mono(meth)acrylate.

The urethane (meth)acrylate (B) contained in the resin composition of the present invention may be synthesized by a common method using the diol compound (b-1) having molecular weight of 48 to 1000, the aromatic polyisocyanate (b-2), and the hydroxyl group-containing (meth)acrylate (b-3). That is to say, for example, a reaction product (I) can be obtained by addition reaction of the diol compound (b-1) having molecular weight of 48 to 1000 and the aromatic polyisocyanate (b-2), and subsequently urethane (meth)acrylate (B) can be obtained by addition reaction of the reaction product (I) and the hydroxyl group-containing (meth)acrylate (b-3).

In the synthesis of the reaction product (I), it is preferable to react 1.1 to 2.0 equivalents of the isocyanate group of the aromatic polyisocyanate (s) (b-2) with 1 equivalent of the hydroxyl group of the diol compound(s) (b-1). It is more preferable to react 1.3 to 2.0 equivalents of the isocyanate group of the aromatic polyisocyanate (s) (b-2) with 1 equivalent of the hydroxyl group of the diol compound(s) (b-1). Preferably, the reaction temperature ranges from 60 to 100° C.

Further, in order to lower the viscosity in the reaction, at least one compound that is not involved in the reaction can also be used as a diluent. As the diluent, a compound of the structure having no hydroxyl group which compound is a monofunctional or difunctional monomer of (meth)acrylate monomer to be described later can also be used.

In the reaction of the reaction product (I) and the hydroxyl group-containing (meth)acrylate (b-3), it is preferable to react 0.95 to 1.1 equivalents of the hydroxyl group of the hydroxyl group-containing (meth) acrylate (s) (b-3) with 1 equivalent of the isocyanate group of the reaction product (I). Preferably, the reaction temperature ranges from 60 to 100° C. In order to accelerate the reaction, for example, a tertiary amine such as triethylamine or benzyldimethylamine, or an alkyl tin dilaurate compound such as dibutyl tin dilaurate or dioctyl tin dilaurate can be used as a catalyst. The addition amount of the catalyst(s) is preferably 0.001 to 5 wt. %, and more preferably 0.01 to 1 wt. % based on the total weight of a reaction mixture.

In order to prevent polymerization in the reaction, for example, a polymerization inhibitor such as hydroquinone, hydroquinone monomethyl ether, p-methoxyphenol or p-benzoquinone may be used. The addition amount of the polymerization inhibitor(s) preferably ranges from 0.001 to 5 wt. %, and more preferably from 0.01 to 1 wt. % base on the total weight of the reaction mixture.

In the resin composition of the present invention, one urethane (meth)acrylate (B) may be used or plural urethane (meth)acrylates (B) may be used together.

Examples of the multifunctional (meth)acrylate (A) having three or more (meth)acryloyl groups in the molecule thereof contained in the resin composition of the present invention include monomers and oligomers having three or more (meth)acryloyl groups in the molecule.

Examples of the multifunctional (meth) acrylate monomers having three or more (meth)acryloyl groups in the molecule
include trimethylolpropane tri(meth)acrylate,
trimethyloloctane tri(meth)acrylate, trimethylolpropane
polyethoxy tri (meth) acrylate, trimethylolpropane polypropoxy
tri (meth) acrylate, trimethylolpropane polyethoxy polypropoxy
tri(meth)acrylate, tris[(meth)acryloyloxyethyl]isocyanurate,
pentaerithritol tri(meth)acrylate, pentaerithritol
polyethoxy tetra(meth)acrylate, pentaerithritol polypropoxy
tetra(meth)acrylate, pentaerithritol tetra(meth)acrylate,
ditrimethylolpropane tetra(meth)acrylate, dipentaerithritol
tetra(meth)acrylate, dipentaerithritol penta(meth)acrylate,
dipentaerithritol hexa(meth)acrylate and
caprolactone-modified
tris[(meth)acryloyloxyethyl]isocyanurate.

Examples of the multifunctional (meth) acrylate oligomers having three or more (meth)acryloyl groups in the molecule include epoxy (meth)acrylate, urethane (meth)acrylate and polyester (meth)acrylate.

Examples of the epoxy (meth)acrylate include reaction products obtained by reacting epoxy resins such as bisphenol A-type epoxy resin, bisphenol F-type epoxy resin, phenol novolak-type epoxy resin, terminal glycidyl ether of propylene oxide adduct of bisphenol A or fluorene epoxy resin with (meth)acrylic acid and having three or more (meth)acryloyl groups in the molecule.

The urethane (meth) acrylate may be a compound other than the urethane (meth)acrylate (B) and examples thereof include compounds having three or more (meth)acryloyl groups in the molecule which are reaction products of a diol compound having molecular weight of more than 1000, the aromatic polyisocyanate and the hydroxyl group-containing (methiacrylate, and compounds having three or more (meth)acryloyl groups in the molecule which are reaction products of a diol compound, chain-like saturated hydrocarbon or cyclic saturated hydrocarbon polyisocyanate, and the hydroxyl group-containing (meth)acrylate.

Examples of the chain-like saturated hydrocarbon or cyclic saturated hydrocarbon polyisocyanate include chain-like saturated hydrocarbon isocyanates such as
tetramethylene diisocyanate, hexamethylene diisocyanate,
2,2,4-trimethylhexamethylene diisocyanate and
2,4,4-trimethylhexamethylene diisocyanate, and cyclic
saturated hydrocarbon isocyanates such as isophorone
diisocyanate, norbornane diisocyanate, dicyclohexylmethane
diisocyanate, methylene bis(4-cyclohexyl isocyanate),
hydrogenated diphenylmethane diisocyanate, hydrogenated
xylene diisocyanate and hydrogenated toluene diisocyanate.

Examples of the polyester (meth)acrylate include reaction products obtained by reacting the polyester diol (b-1-2) with (meth)acrylic acid and having three or more (meth)acryloyl groups in the molecule.

It is suitable for the resin composition of the present invention that the multifunctional (meth)acrylate (A) having three or more (meth)acryloyl groups in the molecule is pentaerithritol tri(meth)acrylate, dipentaerithritol hexa(meth)acrylate, dipentaerithritol penta(meth)acrylate, or tris[(meth) acryloyloxyethyl]isocyanurate. Among them, the multifunctional (meth)acrylate (A) is preferably pentaerithritol tri(meth)acrylate or dipentaerithritol hexa(meth)acrylate, and more preferably dipentaerithritol hexa(meth)acrylate.

The resin composition of the present invention further contains o-phenylphenol polyethoxy acrylate (C) having an average repetition number of ethoxy groups of 1 to 3. The o-phenylphenol polyethoxy acrylate (C) can be obtained by reacting a reaction product of o-phenylphenol and ethylene oxide with (meth) acrylic acid. The reaction of o-phenylphenol and ethylene oxide is performed by a known method, and there are commercially available compounds. In esterification reaction with (meth) acrylic acid, at least one esterification catalyst such as p-toluenesulfonic acid or sulphuric acid, and at least one polymerization inhibitor such as hydroquinone or phenothiazine is used. Preferably, the esterification is performed in the presence of at least one solvent (for example, toluene, cyclohexane, n-hexane or n-heptane) at a temperature in the range of 70 to 150° C. The usage amount of (meth) acrylic acid ranges from 1 to 5 moles, and preferably from 1.05 to 2 moles relative to 1 mole of the reaction product of o-phenylphenol and ethylene oxide. The concentration of the esterification catalyst is 0.1 to 15 mol %, and preferably 1 to 6 mol % relative to (meth)acrylic acid to be used.

Examples of the photopolymerization initiator (D) contained in the resin composition of the present invention include benzoins such as benzoin, benzoin methyl ether, benzoin
ethyl ether, benzoin propyl ether and benzoin isobutyl ether;
acetophenones such as acetophenone,
2,,2-diethoxy-2-phenylacetophenone,
2-2-diethoxy-2-phenylacetophenone, 1,1-dichloroacetophenone,
2-hydroxy-2-methyl-phenylpropan-1-one, diethoxyacetophenone,
1-hydroxycyclohexyl phenyl ketone and
2-methyl-1-[4-(methylthio)phenyl]-2-morpholinopropan-1-one;
anthraquinones such as 2-ethylanthraquinone,
2-t-butylanthraquinone, 2-chloroanthraquinone and
2-amylanthraquinone; thioxanthones such as
2,4-diethylthioxanthone, 2-isopropylthioxanthone and
2-chlorothioxanthone; ketals such as acetophenone dimethyl
ketal and benzyl dimethyl ketal; benzophenones such as
benzophenone, 4-benzoyl-4′-methyldiphenylsulfide and
4,4′-bismethylaminobenzophenone; phosphineoxides such as
2,4,6-trimethylbenzoyldiphenylphosphine oxide and
bis(2,4,6-trimethylbenzoyl)-phenylphosphine oxide. The
   photopolymerization initiator (D) is preferably 2-hydroxy-2-methyl-phenylpropan-1-one and/or 1-hydroxycyclohexyl phenyl ketone. In the resin composition of the present invention, one photopolymerization initiator (D) may be used or two or more photopolymerization initiators (D) may be used together.

For the usage rates of the components contained in the resin composition of the present invention, it is preferable to use 5 to 50 parts by weight of the (A) component(s) based on 100 parts by weight of the (A) component(s), the (B) component(s) and the (C) component(s). It is more preferable to use 10 to 40 parts by weight of the (A) component(s). It is preferable to use 5 to 30 parts by weight of the (B) component(s) based on 100 parts by weight of the (A) component(s), the (B) component(s) and the (C) component(s). It is more preferable to use 10 to 28 parts by weight of the (B) component(s). It is preferable to use 5 to 70 parts by weight of the (C) component(s) based on 100 parts by weight of the (A) component(s), the (B) component(s) and the (C) component(s). It is more preferable to use 10 to 60 parts by weight of the (C) component(s). It is preferable to use 0.1 to 10 parts by weight of the (D) component (s) based on 100 parts by weight of the (A) component(s), the (B) component(s) and the (C) component(s). It is more preferable to use 0.3 to 5 parts by weight of the component(s) (D).

The composition of the present invention may further contain one or more of (meth) acrylate monomers other than the (A) component, the (B) component, and the (C) component and (meth) acrylate oligomers other than the (A) component, the (B) component, and the (C) component in addition to the multifunctional (meth)acrylate (A) having three or more (meth)acryloyl groups in the molecular, the urethane (meth)acrylate (B) and the o-phenylphenol polyethoxy acrylate (C) in consideration of the adhesion, glass transition temperature (Tg) or hardness of the resin composition of the present invention.

Examples of the (meth)acrylate monomers other than the (A) component, the (B) component, and the (C) component include
acryloylmorpholine, 2-hydroxypropyl (meth)acrylate,
4-hydroxybutyl (meth)acrylate, cyclohexane-1,4-dimethanol
mono(meth)acrylate, tetrahydrofurfuryl (meth)acrylate,
phenoxyethyl (meth) acrylate, phenylpolyethoxy (meth) acrylate,
2-hydroxy-3-phenoxypropyl (meth)acrylate,
p-cumylphenoxyethyl (meth)acrylate, isobornyl (meth)acrylate,
tribromophenyloxyethyl (meth)acrylate, dicyclopentanyl
(meth)acrylate, dicyclopentenyl (meth)acrylate,
dicyclopentenyloxyethyl (meth)acrylate, 1,4-butanediol
di(meth)acrylate, 1,6-hexanediol di(meth)acrylate,
1,9-nonanediol di(meth)acrylate, tricyclodecanedimethanol
di(meth)acrylate, bisphenol A polyethoxy di(meth)acrylate,
bisphenol A polypropoxy di(meth)acrylate, bisphenol F
polyethoxy di (meth) acrylate, ethylene glycol di (meth) acrylate,
polyethylene glycol di(meth)acrylate,
tris(acryloxyethyl)isocyanurate and di(meth)acrylate of an
ε-caprolactone adduct of neopentylglycol hydroxypivalate (for
   example, KAYARAD HX-220 and HX-620 manufactured by NIPPON KAYAKU CO. LTD).

Examples of the (meth)acrylate oligomers other than the (A) component, the (B) component, and the (C) component include urethane (meth) acrylate other than the urethane (meth) acrylate (B), epoxy (meth)acrylate and polyester (meth)acrylate, each

having less than three (meth)acryloyl groups in the molecule.

Besides the above-mentioned components, the resin composition of the present invention can include at least one releasing agent, at least one defoamer, at least one leveling agent, at least one light stabilizer, at least one antioxidant, at least one polymerization inhibitor, at least one antistatic agent and/or at least one organic solvent. In addition, if necessary, the resin composition of the present invention may further contain at least one polymer such as acrylic polymer, polyester elastomer, urethane polymer or nitrile rubber.

The resin composition of the present invention can be prepared by mixing and dissolving the components according to a common method. Specifically, the resin composition of the present invention can be obtained by putting the components into a round bottom flask to which a stirrer and a thermometer are attached, and stirring them at a temperature of 40 to 80° C. for 0.5 to 6 hours.

A cured product of the resin composition of the present invention can be obtained by irradiating the resin composition of the present invention with UV and curing it according to a common method. That is to say, the resin composition of the present invention is applied, for example, onto a stamper having a shape corresponding to a fresnel lens, lenticular lens, prism lens or a microlens to form a layer of the resin composition, and a back sheet (for example, a substrate or film made of polymethyl methacrylate, polycarbonate, polystyrene, polyester, or a blend of these polymers) serving as a hard transparent substrate is adhered to the layer, and the resin composition is irradiated with UW emitted by a high pressure mercury lamp from the hard transparent substrate side to cure the resin composition, and the resultant cured product is separated from the stamper. Thus, the cured product of the present invention can be obtained. Processing in a continuous manner can be performed for the cured product as application thereof.

A cured product that is obtained in this manner and has a refractive index of 1.55 or more at 25° C. can also be included in the present invention. The cured product is excellent in releasability, shape reproducibility, and adhesion, and can be used for lenses such as fresnel lenses, lenticular lenses, prism lenses and microlenses. The refractive index can be measured with an Abbe refractometer (model No.: DR-M2 manufactured by Atago Co., Ltd.).

The resin composition of the present invention is useful for lenses such as fresnel lenses, lenticular lenses, prism lenses andmicro lenses, and can also be used for various coating agents and adhesives.

### EXAMPLES

The present invention will be described more specifically by way of examples, but the present invention is not limited to the following examples.

### Synthetic Example 1

A dried vessel was charged with 94.7 parts of o-phenylphenol monoethoxy acrylate prepared on the basis of the method described in Patent document 3, and 139.3 parts of 2,4-tolylene diisocyanate. 143.9 parts of bisphenol A dipropoxydiol (hydroxyl group value; 312 mgKOH/g) was added to the content of the vessel as three divided portions, while heat generation was monitored. The resulting mixture was stirred at 80° C., and reaction thereof was performed for about 10 hours. When NCO (%) was measured and the measurement value reached 11.9%, 95.7 parts of 2-hydroxyethyl acrylate, 0.2 parts of p-methoxyphenol, and 0.06 parts of di-n-butyl tin dilaurate were added to the reaction system, and reaction was performed at 80° C. for about 12 hours. When NCO (%) was measured and the measurement value became 0.1% or less, the reaction was terminated.

### Synthetic Example 2

A dried vessel was charged with 99.4 parts of o-phenylphenol monoethoxy acrylate, and 139.3 parts of 2,4-tolylene diisocyanate. 162.6 parts of bisphenol A tetraethoxydiol (hydroxyl group value; 276 mgKOH/g) was added to the content of the vessel as three divided portions, while heat generation was monitored. The resulting mixture was stirred at 80° C., and reaction thereof was performed for about 10 hours. When NCO (%) was measured and the measurement value reached 11.1%, 95.7 parts of 2-hydroxyethyl acrylate, 0.2 parts of p-methoxyphenol, and 0.06 parts of di-n-butyl tin dilaurate were added to the reaction system, and reaction was performed at 80° C. for about 12 hours. When NCO (%) was measured and the measurement value became 0.1% or less, the reaction was terminated.

### Examples 1, 2, and 3

UV curable resin compositions having compositions shown in Table 1 (numerical values expressed in terms of parts by weight) were prepared. Each of these compositions was so applied onto a lens mold as to have a film thickness of about 50 μm, and an easily adhesive PET film (COSMOSHINE A4300 from Toyobo Co., Ltd.; thickness of 100 μm) was adhered thereto, and a layer of the composition was cured by applying UV thereto at an irradiance of 600 mJ/cm² through the PET film with a high pressure mercury lamp, the cured product was separated from the mold, and thereby a prism lens was obtained. Performance evaluation was conducted for the resin compositions and the obtained cured films (prism lenses). The results are shown in Table 2.

### Comparative Example 1

Since Example 2 of Patent document 3 was used for Comparative Example 1, a resin composition was prepared as follows.

Urethane acrylate (reaction product of polytetramethylene glycol (molecular weight of 650)/ethylene glycol/tolylene diisocyanate/2-hydroxyethyl acrylate) of Synthetic Example 2 of Patent document 3, and a compound (o-phenylphenol diethoxy acrylate) of Synthetic Example 3 of Patent document 3 were synthesized. With respect to Synthetic Example 2 of Patent document 3, specifically 130 parts of polytetramethylene glycol (molecular weight of 650, and OH value of 172.6), 49.6 parts of ethylene glycol, 348 parts of tolylene diisocyanate were mixed, and the temperature of the resultant mixture was raised up, and reaction was performed at 80° C. for 10 hours. Subsequently, 243.6 parts of 2-hydroxyethyl acrylate and 0.4 parts of methoquinone were added to the reaction system, and reaction was performed at 80° C. for 10 hours, and thereby urethane acrylate was obtained. Thirty parts of the urethane acrylate, 15 parts of o-phenylphenol diethoxy acrylate, 45 parts of KAYARAD R-551 (bisphenol A tetraethoxy diacrylate), 10 parts of tribromophenyl acrylate, and 3 parts of Irgacure 184 (1-hydroxycyclohexyl phenyl ketone) were heated to 60° C., and were mixed, and thereby a comparative resin composition was obtained. A prism lens was obtained in the same manner as in Examples. For the resin composition and the obtained cured film (prism lens), performance evaluation was conducted. The results are shown in Table 2.

TABLE 1

| | | | | Comparative |
|---|---|---|---|---|
| | Example | | | Example |
| Composition | 1 | 2 | 3 | 1 |

(A) component

| | | | |
|---|---|---|---|
| pentaerythritol triacrylate | 25 | | |
| dipentaerythritol hexaacrylate | | 25 | 25 |

(B) component

| | | | |
|---|---|---|---|
| urethane acrylate of Synthetic | 19 | 19 | |
| Example 1 | | | |
| urethane acrylate of Synthetic | | | 19 |
| Example 2 | | | |

(C) component

| | | | | |
|---|---|---|---|---|
| o-phenylphenol monoethoxy acrylate | 51 | 51 | 51 | |
| compound (o-phenylphenol diethoxy | | | | 15 |
| acrylate) of Synthetic Example 3 of | | | | |
| Patent document 3 | | | | |

(D) component

| | | | | |
|---|---|---|---|---|
| 1-hydroxycyclohexyl phenyl ketone | 3 | 3 | 3 | 3 |

(the other components)

| | | | | |
|---|---|---|---|---|
| phenyloxyethyl acrylate | 5 | 5 | 5 | |
| urethane acrylate of Synthetic | | | | 30 |
| Example 2 of Patent document 3 | | | | |
| bisphenol A tetraethoxy diacrylate | | | | 45 |
| tribromophenyloxyethyl acrylate | | | | 10 |

### Method for Performance Evaluation

(1)-1 releasability: difficulty or easiness at the time that the cured resin was separated from mold
A . . . the cured resin was well separated from the mold
B . . . it was slightly difficult to separate the cured resin from the mold
C . . . it was difficult to separate the cured resin from the mold or the resin remained on the mold
(1)-2 releasing sound: peeling-off sound at the time that the cured resin was separated from the mold
A . . . no peeling-off sound at the time of releasing
B . . . a little peeling-off sound at the time of releasing
C . . . loud peeling-off sound at the time of releasing
(2) shape reproducibility: The surface shape of the cured layer of the UV curable resin and the surface shape of the mold were observed.
A . . . good reproducibility
C . . . poor reproducibility
(3) adhesion: each of the resin compositions was so applied onto an easily adhesive PET film (COSMOSHINE A4300 from Toyobo Co., Ltd.; thickness of 100 μm) as to have a film thickness of about 50 μm, and irradiated with light emitted by a high pressure mercury lamp (80 W/cm, ozoneless) at an irradiance of 600 mJ/cm² to cure the resin composition to produce a test piece, and evaluation of adhesion thereof was conducted on the basis of JIS K5600-5-6. As for the results, numerals 0 to 2 were evaluated as A, and numerals 3 to 5 were evaluated as C.
(4) Refractive Index (25° C.) : the refractive index (25° C.) of the cured layer of the UV curable resin was measured with an Abbe refractometer (model No.: DR-M2 manufactured by Atago Co. Ltd.).
(5) Glass transition temperature (Tg): The Tg point of the cured layer of the UV curable resin was measured with a viscoelastic measuring system DMS-6000 (manufactured by Seiko electronic industries) in a tensile mode at frequency of 1 Hz.
(6) Stability of liquid: the state of the resin composition after one month storage at room temperature was observed with naked eyes.
A . . . the resin composition did not change
B . . . the resin composition thickened
C . . . the resin composition crystallized

TABLE 2
Evaluation results

| | | | | Comparative |
|---|---|---|---|---|
| | Example | | | Example |
| | 1 | 2 | 3 | 1 |
| Release properties | A | A | A | A |
| Releasing sound | B | A | A | B |
| Mold reproducibility | A | A | A | A |
| properties | | | | |
| Adhesion properties | A | A | A | A |
| Refractive index | 1.577 | 1.577 | 1.575 | 1.571 |
| Tg (° C.) | 82 | 71 | 70 | 59 |
| Stability of liquid | A | A | A | B |

### Example 4

Twenty-five parts of dipentaerithritol hexaacrylate as (A) component, 19 parts of urethane acrylate obtained in Synthetic Example 1 as (B) component, 25 parts of o-phenylphenol monoethoxy acrylate as (C) component, 3 parts of 1-hydroxycyclohexyl phenyl ketones as (D) component, and 21 parts of phenoxyethyl acrylate and 10 parts of 1,6-hexanediol diacrylate as the other components were mixed, and thereby the resin composition of the present invention was obtained. The refractive index of the film obtained by curing the resin composition was 1.556 at 25° C. The resin composition was so applied onto a lens mold as to have a film thickness of 100 to 150 μm, and an MS (styrene-methyl methacrylate copolymer) plate having a thickness of 2.5 mm was adhered thereto, and the resin composition was irradiated with UV emitted by a high pressure mercury lamp at an irradiance of 600 mJ/cm² through the MS plate and cured, the resultant cured product was separated from the mold, and thereby a fresnel lens was obtained.

The releasability and shape reproducibility of the lens were excellent. The adhesion of the cured film to the MS plate was evaluated on the basis of JIS K5600-5-6, and was excellent.

As is apparent from the evaluation results of Examples 1, 2, and 3, and Comparative Example 1 shown in Table 2, the resin composition of the present invention is excellent in stability, and the cured product thereof has a high refractive index, and are excellent in releasability and shape reproducibility, and has good adhesion to the easily adhesive PET and high Tg. Compared with Comparative Example 1, the present invention is excellent particularly in stability, Tg, and refractive index.

As is apparent from the results of Example 4, the cured product of the resin composition according to the present invention has a high refractive index, and is excellent in releasability and shape reproducibility, and has good adhesion to the MS plate.

### INDUSTRIAL APPLICABILITY

The UV curable resin composition of the present invention and the cured product thereof are mainly suitable in particular for lenses such as fresnel lenses, lenticular lenses, prism lenses and microlenses.

1. A resin composition comprising multifunctional (meth)acrylate (A) having three or more (meth)acryloyl groups in a molecule thereof, urethane (meth)acrylate (B) which is a reaction product of a diol compound (b-1) having molecular weight of 48 to 1000, aromatic polyisocyanate (b-2), and hydroxyl group-containing (meth)acrylate (b-3), o-phenylphenol polyethoxy acrylate (C) having an average repetition number of ethoxy groups of 1 to 3, and a photopolymerization initiator (D).

2. The resin composition according to claim 1, wherein the multifunctional (meth)acrylate (A) is pentaerythritol triacrylate or dipentaerythritol hexaacrylate.

3. The resin composition according to claim 1 or 2, wherein the diol compound (b-1) is one or more compounds selected from bisphenol A polyethoxydiol having a repetition number of ethoxy groups of 2 to 8, and bisphenol A polypropoxydiol having a repetition number of propoxy groups of 2 to 6.

4. The resin composition according to any one of claims 1 to 3, further comprising a (meth)acrylate monomer other than the (A) component, the (B) component and the (C) component, and/or a (meth) acrylate oligomer other than the (A) component, the (B) component, and the (C) component.

5. The resin composition according to any one of claims 1 to 4, comprising 10 to 40 wt. % of the (A) component, 10 to 28 wt. % of the (B) component, and 10 to 60 wt. % of the (C) component in the composition based on 100 wt % of the (A) component+the (B) component+the (C) component.

6. The resin composition according to any one of claims 1 to 5, used for lenses.

7. A cured product obtained by curing the resin composition according to any one of claims 1 to 6 and having a refractive index of 1.55 or more at 25° C.

8. A lens using the cured product according to claim 7.
